(19) United States
(12) Patent Application Publication
(10) Pub. No.: US 2026/0355909 A1
(43) Pub. Date: Nov. 12, 2026

(54) Automobile Hard Tubing Brake Line -Axial Loading Hex Socket (Tool)

(71) Applicant: Stephen Andrew Reed, Lebanon, OH (US)

(72) Inventor: Stephen Andrew Reed, Lebanon, OH (US)

(21) Appl. No.: 19/201,171

(22) Filed: May 7, 2025

(51) Int. Cl. B25B 13/06; B25B 13/08; B25B 13/48

(52) U.S. Cl. CPC B25B 13/06; B25B 13/08; B25B 13/481

(57) ABSTRACT

The Automobile Hard Tubing Brake Line—Axial Loading Hex Socket (Tool) is an invention that allows the person having ordinary skill in the art to apply an axial force to the hex fitting of an automobile hard brake line while simultaneously applying a rotation force to the fitting, thus allowing the threads of the fitting to engage in the mating part. This invention will also be useful in any application where hydraulic lines are used and have hard tubing lines with threaded connections.

### BACKGROUND OF THE INVENTION

The present disclosure relates to a tool for working on automobile, hydraulic brake lines. More specifically, the tool is designed to be used on the fitting hex nut utilized to tighten the hard tubing brake lines, plumbed into the distribution block, master cylinder or proportioning valve assembly, located in a fixed position on the automobile.

Factory installed hydraulic brake lines can generally be divided into two categories:
1) Hard tubing brake lines; consisting of metal tubing of fixed length and having fixed curves, running between two brake components that have no relative movement between the two components during operation of the brakes, or the movement of the car. And;
2) Flexible brake lines that consist of end fittings crimped upon flexible high pressure hydraulic hoses. This tool is not designed to be used with the flexible type of brake line.

The advancements of anti-lock brake systems and traction control systems in modern cars necessarily dictate a much more complex hydraulic pressure distribution block for distributing hydraulic pressure to each of the four wheels independently. Many of these distribution blocks have the control computer attached to the unit, and thus if the anti-lock brake system is giving an error code, or malfunctioning, the fix requires the mechanic to replace the hydraulic distribution block, and/or the hard tubing brake lines going to it.

The distribution block is typically made of either an aluminum or steel alloy and has several ports machined to accept the male threads of the previously mentioned hard tubing brake lines. The distribution block is typically mounted on the front frame area of the automobile, and is thus exposed to wet and corrosive environments, along with all the hard tubing brake lines feeding into or coming out of the distribution block.

Factory installed hard tubing brake lines are typically made of steel alloy, bent to specific lengths having very tight curves and a fitting, meant to be threaded into the distribution block for a high-pressure hydraulic connection that is leak free. It is not uncommon for one or more of these lines to corrode and need replacement or for the distribution block/computer to fail and need replacement during the service life of the vehicle.

Replacing any, or all the factory installed hard tubing brake lines during this operation places the mechanic in a difficult situation. Although the aftermarket may support making replacement hard tubing brake lines for popular vehicles for some amount of time, based on vehicle popularity, and potential market demand, there is no guarantee that the aftermarket or even a replacement factory part will fit precisely. Usually, there exists a spring loading force on the hard tubing brake line as it enters the fixed component, once the fixed component is bolted into place at the factory.

To aggravate an already difficult working environment for the mechanic, once the factory installed hard tubing brake line's fittings are broken loose in the distribution block, the congested work area becomes an oily mess from the released brake fluid. This combination makes it extremely difficult for the mechanic to loosen the old fitting, or to start the threads of a new fitting into the distribution block, or other fixed component.

Starting the new (replacement) hard tubing brake line fitting requires that the mechanic exert a significant amount of axial force down onto the fitting hex nut, while being able to turn the fitting hex nut to start the thread engagement. This process can be extremely difficult to do in an oily environment and with limited space, while attempting to overcome the spring force of an improperly bent, or dimensioned brake hard tubing brake line.

Accordingly, the embodiments of the Automobile Hard Tubing Brake Line—Axial Loading Hex Socket (Tool) allow the mechanic to successfully apply the axial load necessary to start the new threads of the hex nut under these difficult working conditions.

### STATE OF THE PRIOR ART

U.S 20170057057A1 discloses an invention for rapidly tightening hydraulic fittings. An open-ended Crow's Foot Wrench design is coupled with a ratchet and used to spin the fitting hex. However, starting with the invention disclosed in the 20170057057A1 it would not be obvious for one having ordinary skill in the art to add a means of applying an axial force to the fitting for the following reasons:
A) The primary focus of the invention disclosed in the 20170057057A1 application is to speed up the tightening operation of the fitting threads, or to apply a final torque value to the fitting.
B) It is assumed by the user of the invention disclosed in the 20170057057A1 application that the threads of the fitting have already been started in the mating part.
C) It is assumed by the invention disclosed in the 20170057057A1 application that the tubing and its mating part will be properly aligned, thus no spring force is present.
D) Due to the Crows Foot open ended wrench design of the invention disclosed in the 20170057057A1 application, if an axial force were exerted by the Crow's Foot Wrench onto the fitting hex, it would also apply a torque moment onto the fitting, thus increasing the likelihood of cross threading the fitting upon rotation.

### BRIEF SUMMARY OF THE INVENTION

The present invention is directed to a hex socket specifically designed for aiding the mechanic in assembly and replacement of the hydraulic brake system, hard tubing brake lines into the distribution block or other stationary (fixed position) brake system components.

The invention includes an Inner Axial Wall at the bottom end of the Inner Hex Structure. The Inner Axial Wall allows the mechanic to apply an axial force to the hard tubing brake line fitting while turning the socket to start the threads of the fitting into the mating fixed position brake component even in an oily condition with limited space to work. Since the Hex Nut Engagement Depth is limited to the approximate length of the corresponding hard tubing brake line fitting hex nut height, it will not interfere with any male thread structure extending beyond the hex configuration of the fitting, thus allowing for interference free axial loading of the threaded fitting needed to start the initial threads into the fixed brake component.

In the preferred embodiment of the invention, the Outer Socket Wall (5) may contain two or more Threaded Holes (8) for inserting small Socket Head Cap Screws (9) to allow for addition torque to be applied to the Tube Fitting Hex (24) of the hard tubing brake line fitting in a space constrained working environment.

Additionally in this embodiment of the invention, the Axial Wall Thickness (4) end of the socket contains an Outer Hex Structure (19), to allow the mechanic to use a hex wrench on the end of the socket once the threads of the fitting have been started in the mating brake component.

In another embodiment of the invention, the open portion of the Sliced Wall (11) may be attached back to the socket to complete the Inner Hex Structure (6) for applications where additional torque is required to spin the hex nut of the hard tubing brake line fitting.

In another embodiment of the invention, the Socket Head Cap Screws (9) may be replaced by any other threaded fastener designed to mate with the Threaded Holes (8) in the side of the socket. This embodiment may utilize a smooth rod surface with threads to form a Tee handle type structure used to thread into Threaded Holes (8). A polymer sleeve may be placed over the body of the Socket Head Cap Screws to increase friction for service in an oily environment.

In another embodiment of the invention the Threaded Holes (8) are simply replaced by drilled holes and the Socket Head Cap Screws (9) would then be replaced by a rod sized to slide into the hole for applying axial force while rotating the socket.

In another embodiment of the invention the Threaded Holes (8) are not present, and the socket has a permanent rod welded or otherwise affixed to the body of the socket for the purpose of applying axial force while rotating the socket.

### BRIEF DESCRIPTION OF THE SEVERAL VIEWS OF THE DRAWINGS

FIG. 1 is a cut away of the side view of the Automobile Hard Tubing Brake Line—Axial Loading Hex Socket (Tool) with the Tube Clearance Slice (22) removed.

FIG. 2 is another cut away view of the Automobile Hard Tubing Brake Line—Axial Loading Hex Socket (Tool) with the Tube Clearance Slice (22) removed. This view shows the Axial Load Direction (20) indicating the direction of the axial load to be applied to the threaded tube fitting.

FIG. 3 is a view of the Automobile Hard Tubing Brake Line—Axial Loading Hex Socket (Tool), once placed into position on the Hard Tubing Brake Line (25), Tube Fitting (27).

FIG. 4 is a top view of Automobile Hard Tubing Brake Line—Axial Loading Hex Socket (Tool).

FIG. 5 is a view of a typical anti-lock brake system hydraulic fluid distribution block (13), having multiple input lines (14) and output (16) hard tubing brake lines. These lines are typically located in close proximity to each other, and the distribution block (13) with the hard tubing brake lines installed is usually mounted to the vehicle frame somewhere below the master cylinder.

### PARTS LIST FROM DRAWINGS

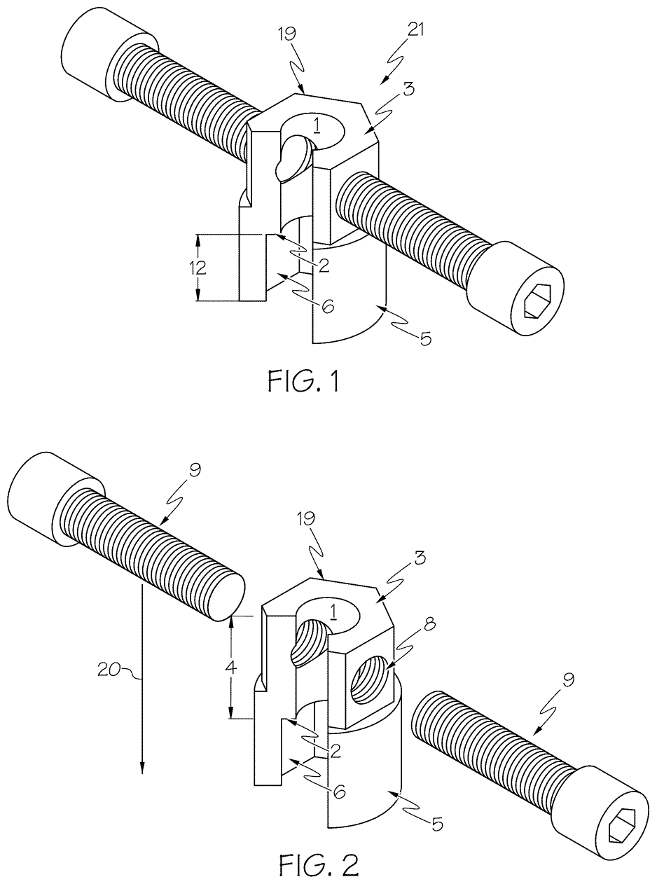

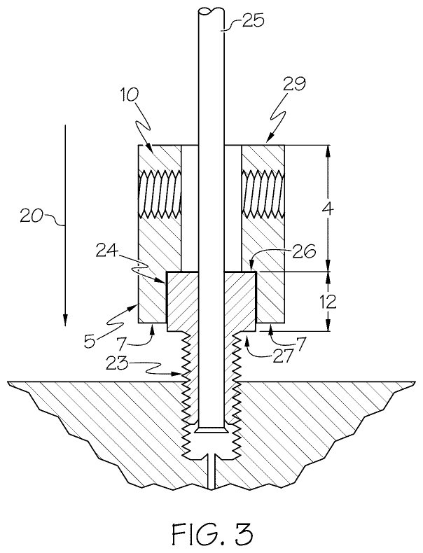

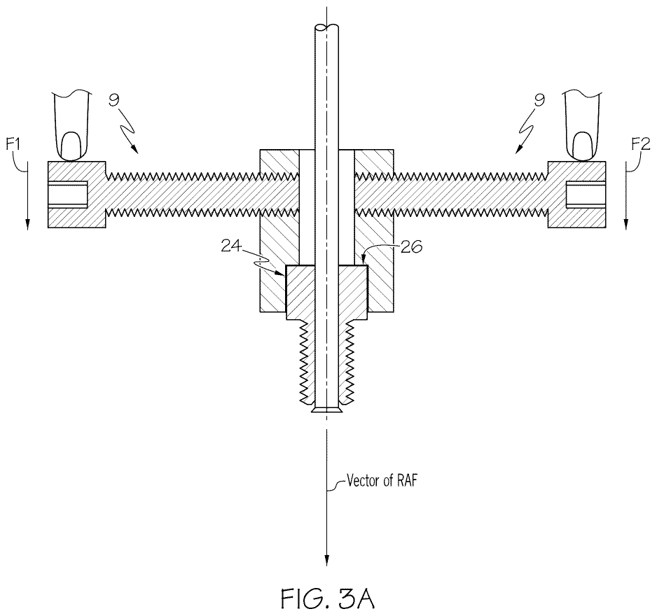

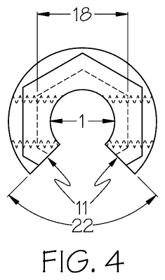

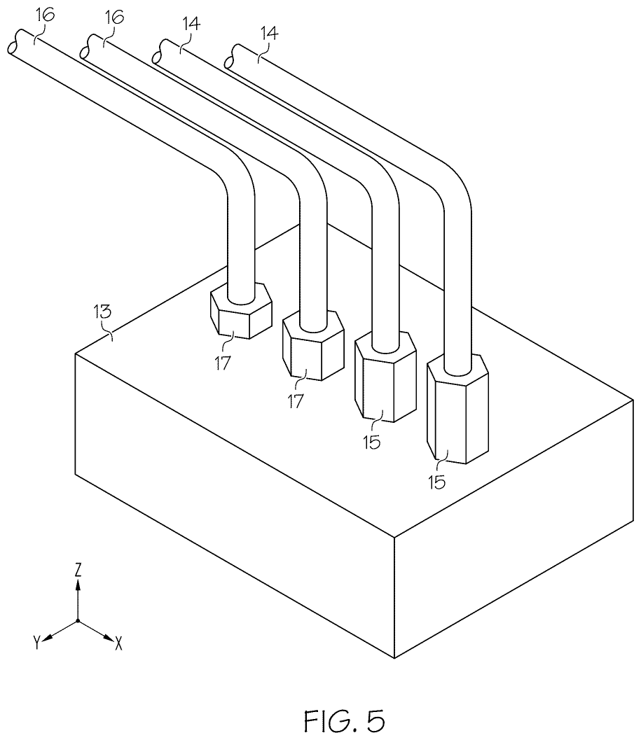

1) Tube Clearance Diameter (FIGS. 1,2, and 4)
2) Inner Axial Wall (FIGS. 1 and 2)
3) Outer Axial Wall (FIGS. 1 and 2)
4) Axial Wall Thickness (FIGS. 2 and 3)
5) Outer Socket Wall (FIGS. 1,2 and 3)
6) Inner Hex Wall Structure (FIGS. 1 and 2)
7) Base End (FIG. 3)
8) Threaded Side Holes (FIGS. 1,2 and 3)
9) Socket Head Cap Screws (FIGS. 1 and 2)
10) Shallow Well Hex Socket (FIG. 3)
11) Sliced Wall (FIG. 4)
12) Hex Nut Engagement Depth (FIGS. 1 and 3)
13) Distribution Block (FIG. 5)
14) Input lines (FIG. 5)
15) Input Line Fittings (FIG. 5)
16) Output Lines (FIG. 5)
17) Output Line Fittings (FIG. 5)
18) Inner Hex Size (FIG. 4)
19) Outer Hex Structure (FIG. 1 and 2)
20) Axial Load Direction (FIGS. 2 and 3)
21) Socket Assembly (FIG. 1)
22) Tube Clearence Slice (FIG. 4)
23) Tube Fitting Threads (FIG. 3)
24) Tube Fitting Hex (FIG. 3)
25) Hard tubing brake line (FIG. 3)
26) Hex Fitting Back Wall (FIG. 3)
27) Tube Fitting (FIG. 3)
29) Axial Wall End of Socket (FIG. 3)
F1=Axial Force applied to left side Socket Head Cap Screw by the user (FIG. 3A)
F2=Axial Force applied to right side Socket Head Cap Screw by the user (FIG. 3A)
RAF=Resultant Axial Force (FIG. 3A)
Vector of RAF=Vector of the Resultant Axial Force (FIG. 3A)
Axial Direction=Z-Direction as shown in FIG. 5

### DETAILED DESCRIPTION OF THE INVENTION

In describing the preferred embodiment of the invention, which is illustrated in the drawings, specific terminology of the invention will be resorted to for the sake of clarity. However, it is not intended to limit the invention to the specific terms used. Rather it is understood that each specific term includes all technical equivalents which operate in a similar manner to accomplish a similar purpose as would be recognized by a person having ordinary skill in the art.

In this detailed description, various terms relating to the direction of force used to install a hard tubing brake line into a fixed position brake system component, including the distribution block, master cylinder, or proportioning valve, are used.

Because the invention has a slice running axially out of approximately ⅕^{th} of its diameter (as shown in FIGS. 1,2 and 4), the invention is meant to be used by sliding it over the Hard Tubing Brake Line (25), beginning at a straight section of the tubing first, and then sliding the invention down over the Tube Fitting Hex (24) of the Tube Fitting (27).

The Axial Loading Direction (20) refers to the direction parallel to the Hard Tubing Brake Line, tubing section, and in the same direction as the advancement of the fitting threads of the tube fitting.

The Automobile Hard Tubing Brake Line—Axial Loading Hex Socket (Tool) is an assembly (21) comprised of the parts shown in the drawings for the invention and described in detail below:

A Shallow—Well Hex Socket (10) having a longitudinal slice removed from the side of the socket is part of the assembly. This slice once removed leaves the socket with two Slice Walls (11) and enables the socket to slide over the Hard Tubing Brake Line (25) and provides clearance needed for rotation around the Hard Tubing Brake Line (25), tubing section by means of a Tube Clearance Diameter (1) formed in the Axial Wall End of the Socket (29).

The Axial Wall End of the Socket (29) is comprised of the Inner Axial Wall (2), the Outer Axial Wall (3) and the Tube Clearance Diameter (1). Together, the Inner Axial Wall (2) and the Outer Axial Wall (3) are reinforced by forming the Axial Wall Thickness (4).

The Outer Socket Wall (5) runs the length of the socket, on the outside of the socket. The Inner Hex Wall Structure (6) runs parallel to the Outer Socket Wall (5) but forms a hexagonal shape on the inside diameter of the socket. Both the Outer Socket Wall (5) and the Inner Hex Wall Structure (6) are joined together at the Base End of the Socket (7), and on the opposite end of the socket, by the Axial Wall Thickness (4) on the Axial Wall End of the Socket (29).

The Axial Wall End of the Socket (29) includes two opposed Threaded Side Holes (8) to allow the opposed, Socket Head Cap Screws (9) to be used to apply both torque, and an axial load to the socket simultaneously, once engaged with the tube fitting hex (24).

The Shallow Well Hex Socket (10) includes two, Sliced Walls (11) defined by the size of the slice removed from the socket as determined by the different tubing size applications. Further, the Hex Nut Engagement Depth (12) is also determined by the different tubing size applications.

The inside dimensions of the Shallow Well Hex Socket are determined by tubing industry standards set forth by SAE, JIS, and DIN among others, and these inside dimensions are defined on the invention by the Hex Nut Engagement Depth (12) and the distance from one Inner Hex Wall Structure across to the opposite side Inner Hex Wall Structure, also referred to as the Inner Hex Size shown as (18) in FIG. 4.

The Shallow Well Hex Socket (10) also includes an Outer Hex Structure (19) located toward the Axial Wall End of the Socket (29) for the purpose of applying additional rotational force (torque) to the tube fitting hex (24).

The Automobile Brake Line—Axial Loading Hex Socket Assembly (21) allows the skilled mechanic to apply both the axial load, and the rotational force (torque) simultaneously to the tube fitting hex (24) thus permitting the threads (23) of the Tube Fitting (27) to start into the mating threads in the fixed component. This is extremely helpful in applications where new tubing must be installed into a fixed brake component, and where the tubing has a spring load due to a slight difference in bend shape, or tube length. Working in this environment can also be extremely frustrating to the mechanic due to the abundance of spilled brake fluid, thus making for slippery conditions on the Hard Tubing Brake Line (25) and its Tube Fitting Hex (24). Here installing the Socket Head Cap Screws (9) into the side of the Shallow Well Hex Socket (10) (once the socket is slid over the tubing hex) permits the mechanic to apply an axial load onto the Hex Fitting Back Wall (26) by way of the Inner Axial Wall (2) making contact with the Hex Fitting Back Wall (26). The direction of the axial load is shown as (20) allows the mechanic to load the threads at the start, or lead-in of the threads, thus allowing the threads of the Tube Fitting (27) to begin pulling into the mating component.

An example of a modern distribution block is shown in FIG. 5. The Distribution Block (13) with Input Lines (14) having Input Line Fittings (15) and Output Lines (16) having Output Line Fittings (17). This illustration shows the tight nature of the tubing bends, and the limited space available for the mechanic to work in, on a typical modern vehicle equipped with antilock brake systems. Although this system was likely assembled as a unit on the production line and is hard bolted into place it is not uncommon for each of the many Hard Tubing Brake Lines to have some amount of spring force on them. Once unthreaded from the distribution block, as would be necessary for the replacement of a line (due to a line rusting out or needing replacement) this spring force requires the mechanic to exert an axial load force to overcome it for the threaded fitting to start in the fixed component. Although automobile manufacturers are required by law to produce some number of spare parts, it is not uncommon for a mechanic engaged in this operation to find out that all of the legally required spare parts inventory, with their factory bends have already been used in the market. This leaves the mechanic with no other option than to custom bend his own tubing, which normally results in a replacement part with less than the precise angle found on the factory installed line. Again, this will likely put the mechanic in a position of having to attempt to start a hard tubing brake line fitting into a constrained space, where the line angles and position make it extremely difficult to start the fitting threads due to the inability to apply both an axial load and a rotational force simultaneously to the threads to allow them to start. Further complicating this operation, it becomes much more difficult once leaking brake fluid saturates the work area. Although mechanics' gloves can help in this situation, they do not offer the user a mechanical advantage. The Automobile Brake Line—Axial Loading Hex Socket Assembly (21) simplifies the work of the mechanic by concentrating the forces needed onto the proper load points of the Hex Fitting Back Wall (26) and the Tube Fitting Hex (24) thus supplying the mechanical advantage necessary for initial thread engagement.

It will be understood by a mechanic, technician, or one skilled in the art of assembling hard tubing brake lines into fixed position brake components that several different tubing sizes and fitting hexes are considered to be standard sizes in the automotive industry, thus the Automobile Hard Tubing Brake Line—Axial Loading Hex Socket (Tool) will have to be manufactured for each specific size hex and tubing size combination.

Further, it will be understood by one skilled in the art, that exerting a force (F1, FIG. 3A) axially onto one of the Socket Head Cap Screws (9, FIG. 3A), while exerting an equal force (F2, FIG. 3A) axially on the opposite side Socket Head Cap Screws (9, FIG. 3A) will yield a resultant axial force (RAF, FIG. 3A). Finally, it will be understood that the resultant force (RAF, FIG. 3A) will have a vector of force in the axial direction, exerted along the centerline of the tubing (Vector of RAF, FIG. 3A). This Resultant Axial Force will be applied to the Hex Fitting Back Wall (26, FIG. 3) by the Inner Axial Wall (2, FIG. 1) of the Automobile Hard Tubing Brake Line—Axial Loading Hex Socket, when fully engaged with the fitting.

Although the Automobile Hard Tubing Brake Line—Axial Loading Hex Socket was conceived while working on an Automobile, and much of this patent application focuses on that type of use, this invention will be useful in any field that utilizes metal tubing having threaded tube compression type fittings. These applications include high pressure hydraulic lines used in the aircraft industry, as well as applications in refrigeration to name a few. For these applications AN (Army-Navy) type threaded connections may be more prevalent, and thus hex size and tubing combinations would need to be adjusted to accommodate use on AN style connection, though these would also be covered under SAE as well as Aerospace Standards.

1. A Socket Assembly for starting the threads of a Hard Tubing Brake Line and its Tube Fitting into a brake system component that is located in a fixed position such as a Distribution Block, wherein the assembly is comprised of a Shallow Well Hex Socket, having an Axial Wall End of the Socket, further comprising a Tube Clearance Slice, a Tube Clearance Diameter, an Inner Axial Wall, an Inner Hex Wall Structure, wherein the Inner Axial Wall and the Inner Hex Wall Structures are perpendicular to each other, and meet to form the inside dimensions of the Shallow Well Hex Socket that allows axial loading on the Tube Fitting Back Wall, the assembly further comprising an Outer Socket Wall, and at least two Threaded Side Holes, and at least two Socket Head Cap Screws, and an Outer Hex Structure, wherein the Hex Nut Engagement Depth is sufficiently shallow to permit the Inner Axial Wall to apply a force in the Axial Load Direction wherein the Axial Wall Thickness prevents deflection of the Outer Axial Wall when the axial load is applied and wherein the Hex Nut Engagement Depth is shallow enough to permit axial loading, in the Axial Load Direction of the Hex Fitting Back Wall without the Base End making contact with the fixed component, when the Tube Fitting Threads are being rotated to start engagement of the threads in the mating threads of the fixed component, wherein the dimensions of the Inner Hex Size, the Hex Nut Engagement Depth the Tube Clearance Diameter and the Tube Clearance Slice will be determined by the specific application.

2. The assembly of claim 1 further comprising Socket Head Cap Screws of a few different lengths for use in spaces with confined access.

3. The assembly of claim 1 wherein the Inner Hex Wall Structure is comprised of a metal that has been subjected to a surface hardening treatment to extend the tool's service life.

4. The assembly of claim 1 wherein the exact dimensions of the tool are determined to match industry standard fitting dimensions set forth by SAE, JIS, DIN or Aerospace Standards as well as other defined tube fitting standards.

5. The assembly of claim 1 wherein the assembly will be dimensioned for other uses utilizing high pressure hydraulic or high-pressure gas, hard line tubing and fittings including the aerospace industry and refrigeration industry.

6. A device for applying axial force and rotational force to the hexagonal head of a hydraulic fitting, wherein the device includes a longitudinal slice which is effective to receive the hard tubing of a hydraulic system wherein the device is comprised of an Inner Hex Wall Structure and an Inner Axial Wall forming a shallow well, effective for receiving and loading the hydraulic fitting hex and back wall simultaneously.
